(19) United States
(12) Patent Application Publication
(10) Pub. No.: US 2005/0163379 A1
(43) Pub. Date: Jul. 28, 2005

(54) Use of multimedia data for emoticons in instant messaging

(75) Inventor: Remy Zimmermann, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/767,132

(22) Filed: Jan. 28, 2004

(51) Int. Cl. G06F 9/44; G06K 9/46

(52) U.S. Cl. 382/190; 719/328

(57) ABSTRACT

The present invention provides a method, and corresponding apparatus, for use of emoticons in IM applications by using sensory information captured by a device. Such information can include video, still image, and/or audio information. In one embodiment, based on a trigger to the system, multimedia input is captured, and relevant features are extracted from it. The extracted information is interpreted, and the interpreted information is mapped onto one or more specific pre-existing emoticons. These specific emoticons are then inserted into the IM communication via an IM API. In another aspect of the present invention, new emoticons are created based on the multimedia information captured. This can include generation of realistic emoticons based on the expressions on the user's face. Animated emoticons can also be created.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to instant messenger services, and more specifically to use of emoticons in instant messaging.

Over the past few years, contact established by people with each other electronically has increased tremendously. Various modes of communication are used to electronically communicate with each other, such as emails, text messaging, etc. In particular, Instant Messaging (IM), which permits people to communicate with each other over the Internet in real time (“IM chats”), has become increasingly popular.

Several IM programs are currently available, such as ICQ from ICQ, Inc., America OnLine Instant Messenger (AIM) from America Online, Inc. (Dulles, Va.), MSN® Messenger from Microsoft Corporation (Redmond, Wash.), and Yahoo!® Instant Messenger from Yahoo! Inc. (Sunnyvale, Calif.).

While these IN services have varied user interfaces, most of them work in the same basic manner. Each user chooses a unique user ID (the uniqueness of which is checked by the IM service), as well as a password. The user can then log on from any machine (on which the corresponding IN program is downloaded) by using his/her user ID and password. The user can also specify a “buddy list” which includes the userids and/or names of the various other IM users with whom the user wishes to communicate.

These instant messenger services work by loading a client program on a user's computer. When the user logs on, the client program calls the IM server over the Internet and lets it know that the user is online. The client program sends connection information to the server, in particular the Internet Protocol (IP) address and port and the names of the user's buddies. The server then sends connection information back to the client program for those of those buddies who are currently online. In some situations, the user can then click on any of these buddies and send a peer-to-peer message without going through the IM server. In other cases, messages may be reflected over a server. In still other cases, the IM communication is a combination of peer-to-peer communications and those reflected over a server. Each IM service has its own proprietary protocol, which is different from the Internet HTTP (HyperText Transport Protocol).

Conventionally, when two users are logged in to an IM program, they can communicate with each other using text. More recently, IM programs also permits users to communicate not only using text alone, but also using audio, still pictures, video, etc. Furthermore, use of “emoticons” has also become very common in IM programs. Emoticons are graphics which are used to visually express the user's emotions/feelings, and enhance the text/words the user is employing. Thus emoticons could be considered the equivalent of seeing an expression on a person's face during a face-to-face conversation.

Several emoticons are currently insertable by a user during an IM chat. Some examples of commonly used emoticons include [symbol] (smiling face), [symbol] (sad face), etc. Currently, IM applications include a selection of predefined available emoticons. These available emoticons are generally inserted in an IM chat in one of the following ways. One way for the user to insert an emoticon is to include a certain set of ASCII characters corresponding to an emoticon. For example, most IM applications will insert the smiling face shown above when the user enters a colon “:”, followed by a dash “-”, followed by a right bracket “)”. Another way for the user to insert an emoticon into an IM chat is to select an emoticon from a selection of available emoticons by clicking on it.

More recently, some customizable emoticons have become available on some IM applications. For example, a feature is available in MSN messenger which allows the user to import an image from the file system. The image selected by the user is rescaled to match the resolution of emoticons. However, even for such customizable emoticons, the image file has to be already available, and such customized emoticons are inserted in an IM chat in the manners described above.

There are several problems with the current use of emoticons, some of which are described below. First, the use of predefined sets of ASCII characters to denote specific emoticons requires the user to memorize the ASCII character sets corresponding to various emoticons. The standard user remembers very few of these ASCII character sets, and thus his repertoire of emoticons used is extremely limited. Second, inserting an emoticon by clicking on it still limits the user, in most cases, to the small selection of emoticons which are easily clickable from an IM chat window. Third, the current use of emoticons does not allow for the insertion of emoticons based on an automatic assessment of the actual emotion of the user. Rather, the emoticons are linked to the user's portrayal of an emotion. This may be analogized to, in the context of a face-to-face conversation, actively “making a face”, versus having the other person simply view the speaker's natural expressions. Fourth, the user is restricted by the predefined emoticons and cannot create new emoticons in real-time.

U.S. Pat. No. 6,629,793 discusses the use of a keyboard having keys for generating emoticons and abbreviations. However, this does not provide a solution for users of regular keyboards. In addition, this does not allow for the insertion of emoticons based on an automatic assessment of the emotion of the user.

U.S. Pat. No. 6,453,294 briefly discusses audio-to-text (and vice versa) transcoding, where certain speech (e.g., “big smile”) would insert the appropriate emoticon into the text communication. However, such a system is limited by the limitations inherent in speech recognition systems. Moreover, the creation of new emoticons is not discussed.

U.S. Pat. Nos. 6,232,966 and 6,069,622 disclose a method and system for generating comic panels. The patents discuss the generation of expression and gestures of the comic characters based on text and emoticons. However, these patents deal with processing of already existing emoticons, rather than how these emoticons are generated.

Thus there exists a need for a system and method which permits the creation of “new” emoticons. In addition, there exists a need for a system and method which permits the insertion of emoticons in more user-friendly and natural manners.

### BRIEF SUMMARY OF THE INVENTION

The present invention provides a method, and corresponding apparatus, for advanced use of emoticons in IM applications by using sensory information captured by a device. Such information can include video, still image, and/or audio information.

In one aspect of the present invention, a system in accordance with an embodiment of the present invention uses multimedia input as a basis for insertion of emoticons in IM communications. Based on a trigger to the system, multimedia input is captured, and relevant features are extracted from it. The extracted information is interpreted, and the interpreted information is mapped onto one or more specific pre-existing emoticons. These specific emoticons are then inserted into the IM communication via an IM API.

In another aspect of the present invention, new emoticons are created based on the multimedia information captured. For instance, a still image of a user could be captured and used as an emoticon. As another example, realistic emoticons can be generated based on the expressions on the user's face. Animated emoticons can also be created.

In yet another aspect of the present invention, new/customized emoticons are created, and are inserted into an IM communication based on the capture of multimedia information, and the extraction/interpretation and mapping discussed briefly above.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of one embodiment of a conventional IM system.

FIG. 2 is a block diagram of a system in accordance with an embodiment of the present invention.

FIG. 3 is a flowchart illustrating the functioning of a system in accordance with an embodiment of the present invention, where emoticons are inserted into an IM communication based on multimedia information captured.

FIG. 4 is a flowchart illustrating the function of a system in accordance with an embodiment of the present invention, where customized emoticons are created and inserted into an IM communication.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the present invention relates to any type of sensory data that can be captured by a device, such as, but not limited to, still image, video, or audio data. For purposes of discussion, most of the discussion in the application focuses on still image, video and/or audio data. However, it is to be noted that other data, such as data related to smell, could also be used. For convenience, in some places “image” or other similar terms may be used in this application. Where applicable, these are to be construed as including any such data capturable by a digital camera.

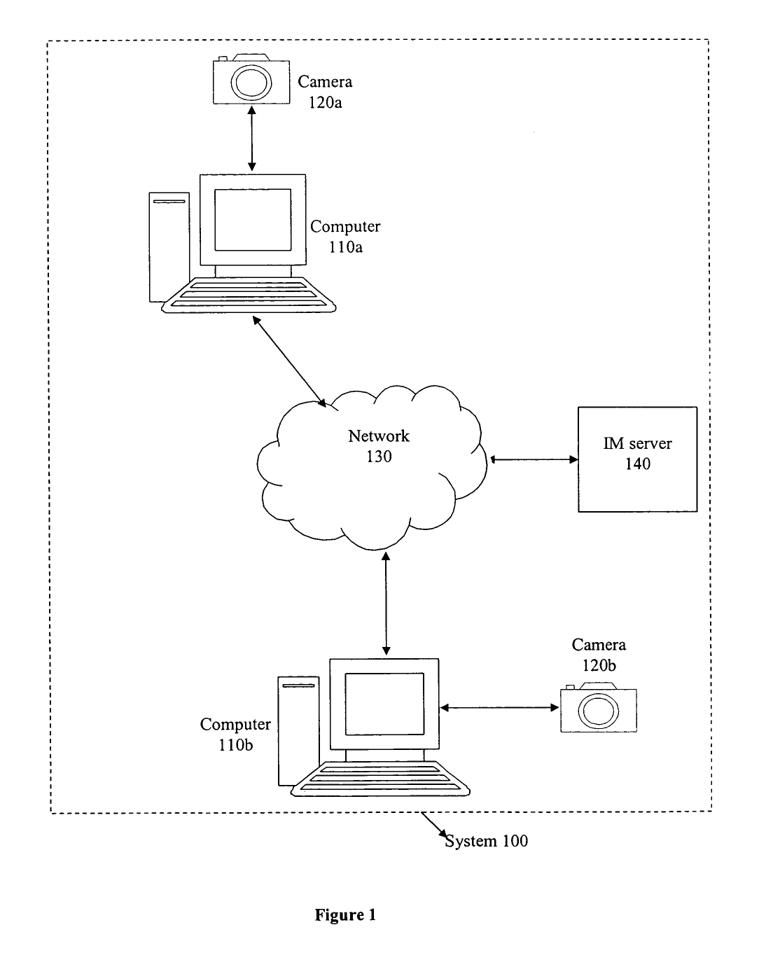

FIG. 1 is a block diagram of one embodiment of a conventional IM system 100. System 100 comprises computer systems 110a and 110b, cameras 120a and 120b, network 130, and an IM server 140.

The computer systems 110a and 110b are conventional computer systems, that may each include a computer, a storage device, a network services connection, and conventional input/output devices such as, a display, a mouse, a printer, and/or a keyboard, that may couple to a computer system. The computer also includes a conventional operating system, an input/output device, and network services software. In addition, the computer includes IM software for communicating with the IM server 140. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.).

Cameras 120a and 120b are connected to the computer systems 110a and 110b respectively. Cameras 120a and 120b can be any cameras connectable to computer systems 110a and 110b. For instance, cameras 120a and 120b can be webcams, digital still cameras, etc.). In one embodiment, cameras 120a and/or 120b are QuickCam® from Logitech, Inc. (Fremont, Calif.).

The network 130 can be any network, such as a Wide Area Network (WAN) or a Local Area Network (LAN), or any other network. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). The network 120 may also include commercially available subscription-based services such as, for example, AOL from America Online, Inc. (Dulles, Va.) or MSN from Microsoft Corporation (Redmond, Wash.).

The IM server 140 can host any of the available IM services. Some examples of the currently available IM programs are America OnLine Instant Messenger (AIM) from America Online, Inc. (Dulles, Va.), MSN® Messenger from Microsoft Corporation (Redmond, Wash.), and Yahoo!® Instant Messenger from Yahoo! Inc. (Sunnyvale, Calif.).

It can be seen from FIG. 1 that cameras 120a and 120b provide still image, video and/or audio information to the system 100. Such multi-media information will be harnessed by the present invention for purposes of presence/status management and/or identity detection.

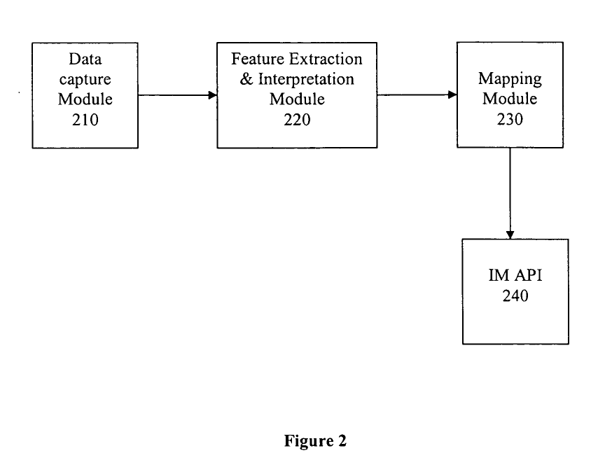

FIG. 2 is a block diagram of a system 200 in accordance with an embodiment of the present invention. System 200 is an example of a system which inserts emoticons based upon information extracted from captured multimedia information. System 200 comprises an information capture module 210, an information extraction and interpretation module 220, a mapping module 230, and an IM Application Program Interface (API) 240.

In one embodiment, the information capture module 210 captures audio, video and/or still image information in the vicinity of the machine on which the user uses the IM application. Such a machine can include, amongst other things, a Personal Computer (PC), a cell-phone, a Personal Digital Assistant (PDA), etc. In one embodiment, the information capture module 210 includes the conventional components of a digital camera, which relate to the capture and storage of multi-media data. In one embodiment, the components of the camera module include a lens, an image sensor, an image processor, and internal and/or external memory.

The information extraction and interpretation module 220 serves to extract information from the captured multi-media information. Such information extraction and interpretation can be implemented in software, hardware, firmware, etc. Any number of known techniques can be used for information extraction and analysis. Relevant features from the captured information are extracted. For instance, face recognition techniques can be used to identify the user's face. The shape of different features of the user's face could then be determined. Any techniques known in the art could be used for such feature extraction. For example, the shape of a user's lips could be used to interpret whether a user is smiling. As another example, the positions of a user's eyes could be used to interpret whether a user is winking. In one embodiment, the output of the information extraction and interpretation module is independent of the API 240 to which the information is eventually supplied. For instance, the output of the information extraction and analysis module may simply indicate that “the user is smiling” or “the user is winking” etc.

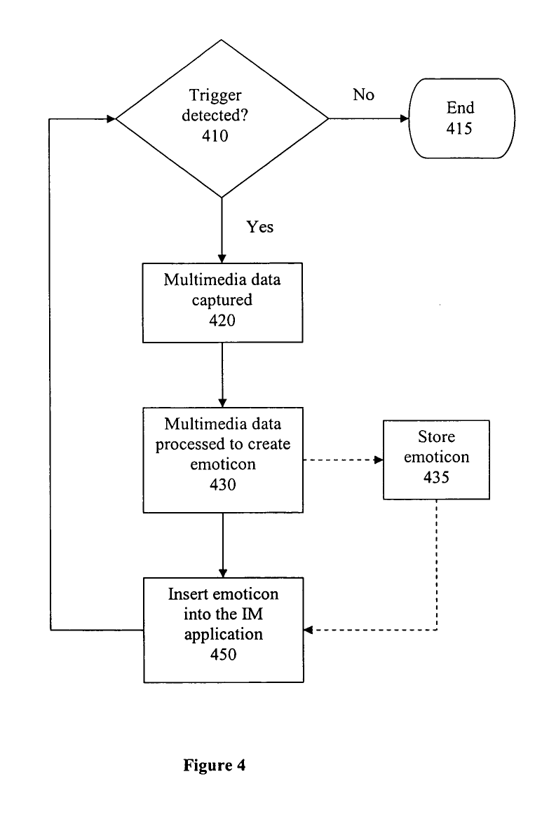

The information mapping module 230 then takes this output and maps it to specific emoticons. For instance, the output “the user is smiling” may be mapped, for an IM application, to a specific emoticon. The emoticons to which the output of the extraction and interpretation module 220 is mapped may be of various different kinds. For instance, these emoticons could be emoticons which are already available in the IM application. In another instance, these emoticons could be emoticons available through a third-party. The emoticons could be static or animated. As another example, these emoticons could also be customized emoticons that the user creates. These customized emoticons could be created in various ways. One way in which customized emoticons can be created is described below with reference to FIG. 4. It is to be noted that the mapping module 230 can be implemented in software, hardware, firmware, etc., or in any combination of these.

The mapped information is then provided to the API 240 for the IM application. The IM API 240 can then use this mapped information to insert the emoticon to which the captured data has been mapped, into the IM chat window.

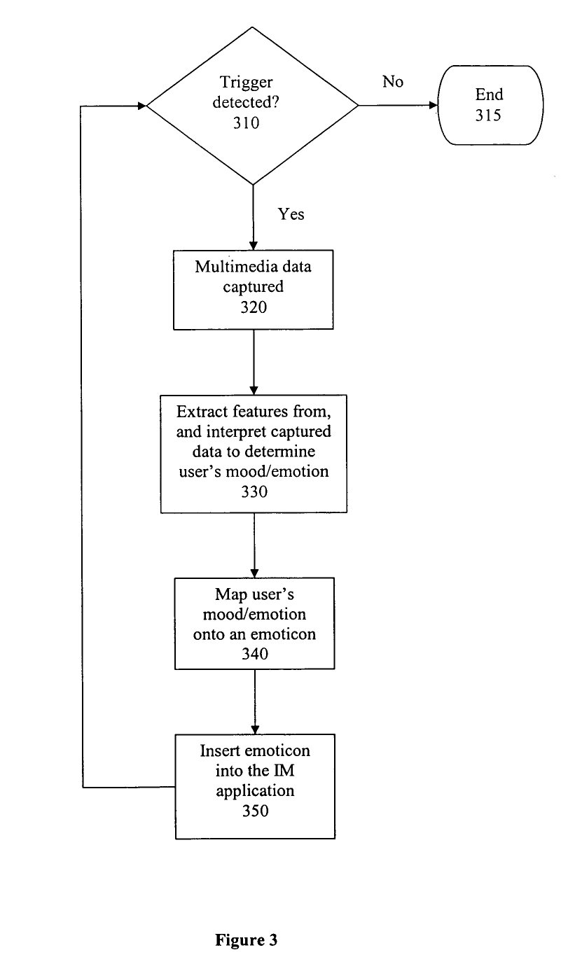

The detailed functioning of the various modules illustrated in FIG. 2 is discussed with reference to FIG. 3. FIG. 3 is a flowchart illustrating the functioning of a system 200 in accordance with an embodiment of the present invention.

In one embodiment, as can be seen from FIG. 3, system 200 has to determine (step 310) whether or not the system 200 has received a trigger to enter an embodiment of the present invention. If the system 200 has not received a trigger, no further action is taken (step 315). If the system receives a trigger, then certain steps described below are implemented. There are several ways in which the system 200 could be triggered. In one embodiment, the system 200 is triggered any time when a user is logged into an IM application. In another embodiment, the user may explicitly have to trigger the system 200. The user may do this, for instance, by pressing a specific physical button, or making certain selections on a computer or on the camera itself, provide a voice command, etc. In still another embodiment, the trigger is set off by the user performing a predetermined gesture, which is recognized by the system as the trigger. In another embodiment, a specific ASCII character set typed by the user could serve as the trigger. In yet another embodiment, predefined events can serve as the trigger. Such trigger events can include, for example, a lapse of a certain predefined time period, etc.

When the system 200 has received a trigger (step 310), it continually captures (step 320) sensory data (e.g., still image, video and/or audio data) captured by the information capture module 210.

Relevant information is then extracted (step 330) and interpreted from this captured data. As mentioned above with respect to FIG. 2, various techniques can be used to extract and interpret information. In one embodiment, based on the image captured, relevant features of the user's face are extracted. In one embodiment, the extracted information is quantized to match predefined user emotions. In another embodiment, the extracted information is used to create a thumbnail of the user's face with accentuated expression information. In yet another embodiment, this information is used to create low resolution images of the user's face with accentuated expression information. In the latter two cases, new “emoticons” are created. This is discussed in further detail below with reference to FIG. 4.

Referring to FIG. 3, the interpreted information is then mapped (step 340) to an emoticon. In one embodiment, this emoticon can be an emoticon predefined in the IM application. In another embodiment, the emoticon could be predefined by a third party. In yet another example, the emoticon could be a customized emoticon. Creation of customized emoticons in accordance with an embodiment of the present invention is described below with reference to FIG. 4.

Some examples of the mapping of the output of the extraction and interpretation module 220 onto emoticons are provided in Table 1 below.

TABLE 1

| Interpreted Information | Map to output |
|---|---|
| User is smiling | [symbol] |
| User is frowning | [symbol] |
| User is winking | [symbol] |
| User is wearing sunglasses | [symbol] |

In a second aspect of the present invention, a system in accordance with an embodiment of the invention can be used for creating and inserting customized emoticons in an IM communication. FIG. 4 is a flowchart which illustrates the functioning of such a system in accordance with one embodiment of the present invention.

As can be seen from FIG. 4, the system needs to determine (step 410) whether or not a trigger for creation (and in some cases, insertion) of emoticons, has been received. As described above with reference to FIG. 3, the trigger can be provided to the system in various different ways. If no trigger is received, no further action is taken (step 415).

If a trigger is received, the following series of actions is taken. Multimedia information is captured (step 420). In one embodiment, such multimedia information includes still images. In another embodiment, such multimedia information includes video. In yet another embodiment, such multimedia information includes audio. In still another embodiment, such multimedia information includes a combination of still image, video, audio, etc.

The captured multimedia information is then processed (step 430) to create emoticons. The processing (step 430) of the captured multimedia information to create emoticons can include, amongst other things, reduction in the size of a captured still image, reduction of the resolution of a captured still image, animation of a captured still image, selection of certain frames from a video clip, etc. In one embodiment, processing (step 430) includes generating a stylized version of the user's “face” from the captured multimedia information.

The processed multimedia information is then inserted (step 440) as an emoticon in an IM communication. In one embodiment, this insertion (step 440) is in real-time. For example, upon reception of the trigger, a still image of the user is captured (step 420), processed (step 430), and inserted (step 440) into the IM communication. In another embodiment, the insertion (step 440) into an IM communication is at a later time. For example, upon reception of the trigger, a still image of the user is captured (step 420), processed (step 430), and then stored (step 435). The stored information is then later inserted (step 440) into an IM communication. This later insertion can be governed by various factors. In one embodiment, this insertion can be as described in FIG. 3. That is, the stored information can be used as a customized emoticon onto which the output of the extraction/interpretation module 220 can be mapped (step 340).

It is to be noted that, as IM applications evolve, emoticon will have more capabilities. For example, in the current version of Yahoo Messenger, the emoticons are animated. Therefore, the emoticons generated could be video sequences instead of being static. Further, it is to be noted that the generation and insertion of emoticons described herein is not limited to IM applications, but rather can be used for other applications (e.g., email) as well as for insertion in other electronic communications and/or media.

As will be understood by those of skill in the art, the present invention may be embodied in other specific forms without departing from the essential characteristics thereof. For example, any of the modules in the systems described above may be implemented in software, hardware, or a combination of these. As another example, users may be able to define various trigger events, and the actions corresponding to each trigger event. As yet another example, other information, such as information relating to smell, movement (e.g., walking, running), location (e.g., information provided by a Global Positioning System), fingerprint information, other biometric information, etc. may be used as inputs to a system in accordance with the present invention. While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention, which is defined in the following claims.

1. A system for mapping captured multimedia information onto emoticons for insertion into a communication using an Instant Messaging (IM) application, wherein the insertion is based on multimedia information, the system comprising:
an information capture module for capturing the multimedia information in the vicinity of a machine on which the user is using the IM application;
an information extraction and interpretation module communicatively coupled with the information capture module, for extracting relevant information from the captured multimedia information and interpreting it; and
a mapping module communicatively coupled with the information extraction and interpretation module, for mapping the interpreted information onto an emoticon.

2. The system of claim 1, wherein the multimedia information comprises at least one of audio information, still image information, and video information.

3. The system of claim 1, further comprising:
an Application Program Interface module for the IM application, communicatively coupled to the mapping module, for inserting the emoticon into the communication using the IM application.

4. The system of claim 1, wherein the emoticon is predefined by the IM application.

5. The system of claim 1, wherein the emoticon is predefined by a third-party application.

6. The system of claim 1, wherein the emoticon is created by the user.

7. The system of claim 6, wherein the emoticon is created by the user by processing captured multimedia information.

8. A method for mapping captured multimedia information onto emoticons for insertion into a communication using an Instant Messaging (IM) application, wherein the insertion is based on multimedia information, the method comprising:
receiving the captured multimedia information;
interpreting the captured multimedia information; and
mapping the interpreted information onto an emoticon.

9. The method of claim 8, wherein the multimedia information comprises at least one of audio information, still image information, and video information.

10. The method of claim 8, further comprising:
inserting the emoticon into the communication using the IM application.

11. The method of claim 8, wherein the step of mapping the interpreted information onto an emoticon comprises:
selecting one emoticon out of a plurality of emoticons predefined in the IM application.

12. The method of claim 8, wherein the step of mapping the interpreted information onto an emoticon comprises:
selecting one emoticon out of a plurality of emoticons predefined in a third-party application.

13. The method of claim 8, wherein the step of mapping the interpreted information onto an emoticon comprises:
selecting one emoticon out of a plurality of customized emoticons created by the user.

14. The method of claim 8, further comprising:
determining whether a trigger has been received;
responsive to the trigger being received, capturing the multimedia information.

15. A method for creating an emoticon for a communication using an IM application, based on captured multimedia information, the method comprising:
receiving the captured multimedia information; and
processing the received captured multimedia information to create an emoticon.

16. The method of claim 15, further comprising:
inserting the emoticon into the communication using the IM application.

17. The method of claim 15, further comprising:
storing the emoticon for use in a later IM communication using the application.

18. The method of claim 15, wherein the step of processing the received captured multimedia information to create an emoticon comprises:
reducing the size of the captured multimedia information.

19. The method of claim 15, wherein the step of processing the received captured multimedia information to create an emoticon comprises:
reducing the resolution of the captured multimedia information.

20. The method of claim 15, wherein the step of processing the received captured multimedia information to create an emoticon comprises:
selecting a frame from a plurality of frames of the captured multimedia information.

21. A system for mapping captured multimedia information onto emoticons for insertion into an electronic medium, wherein the insertion is based on multimedia information, the system comprising:
an information capture module for capturing the multimedia information in the vicinity of a machine in communication with the electronic medium;
an information extraction and interpretation module communicatively coupled with the information capture module, for extracting relevant information from the captured multimedia information and interpreting it; and
a mapping module communicatively coupled with the information extraction and interpretation module, for mapping the interpreted information onto an emoticon.

22. The system of claim 21, wherein the multimedia information comprises at least one of audio information, still image information, and video information.

23. The system of claim 21, further comprising:
an Application Program Interface module, communicatively coupled to the mapping module, for inserting the emoticon into the electronic medium.

24. A method for mapping captured multimedia information onto emoticons for insertion into an electronic medium, wherein the insertion is based on multimedia information, the method comprising:
receiving the captured multimedia information;
interpreting the captured multimedia information; and
mapping the interpreted information onto an emoticon.

25. The method of claim 24, wherein the multimedia information comprises at least one of audio information, still image information, and video information.

26. The method of claim 24, further comprising:
inserting the emoticon into the electronic medium.

27. A system for mapping captured multimedia information onto emoticons for insertion into an electronic communication, wherein the insertion is based on multimedia information, the system comprising:
an information capture module for capturing the multimedia information in the vicinity of a machine the user is using for the electronic communication;
an information extraction and interpretation module communicatively coupled with the information capture module, for extracting relevant information from the captured multimedia information and interpreting it; and
a mapping module communicatively coupled with the information extraction and interpretation module, for mapping the interpreted information onto an emoticon.

28. The system of claim 27, wherein the multimedia information comprises at least one of audio information, still image information, and video information.

29. The system of claim 27, further comprising:
an Application Program Interface module, communicatively coupled to the mapping module, for inserting the emoticon into the electronic communication.
